(19) United States
(12) Patent Application Publication
(10) Pub. No.: US 2012/0283912 A1
(43) Pub. Date: Nov. 8, 2012

(54) SYSTEM AND METHOD OF STEERING OVERRIDE END DETECTION FOR AUTOMATED LANE CENTERING

(75) Inventors: Jin-Woo Lee, Rochester Hills, MI (US); Bakhtiar Brian Litkouhi, Washington, MI (US)

(73) Assignee: GM GLOBAL TECHNOLOGY OPERATIONS LLC, DETROIT, MI (US)

(21) Appl. No.: 13/101,346

(22) Filed: May 5, 2011

(51) Int. Cl. B62D 6/00; G06F 19/00

(52) U.S. Cl. 701/41; 701/36

(57) ABSTRACT

A method and system may measure one or more vehicle dynamics measurements and activate an automatic vehicle control system based on the one or more measurements. The vehicle dynamics measurements may include a vehicle steering angle measurement, vehicle lane offset measurement, or other vehicle dynamics measurements. The automatic vehicle control system may include an automated lane centering system, lane keeping assist, or other autonomous vehicle steering control system.

### TECHNICAL FIELD

The present invention is related to methods and systems to automatically engage a vehicle autonomous steering control system based on, for example, a combination of vehicle measured steering angle, vehicle lane offset and other data.

### BACKGROUND

Many vehicles are equipped with autonomous and/or semi-autonomous driving systems, applications, and/or features. Autonomous and semi-autonomous driving systems may provide automated driving controls that reduce the driver action required for operating the vehicle. Cruise control systems, for example, are a common semi-autonomous driving application. Cruise control systems may function by automatically controlling the vehicle throttle to maintain the driver inputted speed. Automated lane centering methods and applications, for example, may be activated by the driver while the vehicle is in motion and may maintain the vehicle position in the center of a lane. Adaptive lane centering systems, may maintain a constant lane offset, or vehicle position relative to a lane on the road the vehicle is driving upon. Adaptive lane centering systems may reduce driver fatigue and increase safety by maintaining the vehicle position with respect to the road with reduced driver input.

Safety considerations may be taken into account when designing a vehicle lane centering system. In order to conform to safety requirements, an adaptive lane centering application may be overridden by the driver at any time. When the driver overrides the vehicle lane centering system, the system relinquishes full steering control of the vehicle to the driver. A lane centering system typically remains disengaged until the driver physically re-activates the system. If the driver is frequently avoiding small obstacles, changing lanes, or otherwise adjusting direction of vehicle travel during a drive, the vehicle lane centering system may be repetitively disengaged and manually reengaged by the driver. Repetitively disengaging and manually reengaging the vehicle lane centering system may lead to driver fatigue, may divert the driver's focus from other important driving functions, and may dissuade the driver from using the lane centering system.

### SUMMARY

A method and system may measure one or more vehicle dynamics measurements or quantities and activate an automatic vehicle control system based on the one or more vehicle dynamics measurements. The one or more vehicle dynamics measurements may include a steering angle measurement, vehicle lane offset measurement, vehicle speed, vehicle yaw rate, vehicle acceleration, or other measurements. The automatic vehicle control system may include an automated lane centering system, lane keeping assist, or other autonomous vehicle steering control system.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic diagram of a vehicle with an automated steering engagement system according to an embodiment of the present invention;

FIG. 2 is a schematic diagram of a vehicle automated steering engagement system according to an embodiment of the present invention;

FIG. 3 is a schematic diagram of a vehicle automated steering engagement system process according to an embodiment of the present invention;

FIG. 4 is a graph of vehicle steering angle with respect to time according to an embodiment of the present invention;

FIG. 5 is a graph of vehicle lane offset with respect to time according to an embodiment of the present invention;

FIG. 6 is a flowchart of a method according to an embodiment of the invention; and

FIG. 7 is a flowchart of a method according to an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements. Moreover, some of the blocks depicted in the drawings may be combined into a single function.

### DETAILED DESCRIPTION

In the following detailed description, numerous specific details are set forth in order to provide a thorough understanding of the invention. It will however be understood by those skilled in the art that the present invention may be practiced without these specific details. In other instances, well-known methods, procedures, and components have not been described in detail so as not to obscure the present invention.

Unless specifically stated otherwise, as apparent from the following discussions, throughout the specification discussions utilizing terms such as “processing”, “computing”, “storing”, “determining”, “evaluating”, “calculating”, “measuring”, “providing”, “transferring”, or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Autonomous, semi-autonomous or automatic steering control features (e.g., automated lane centering, adaptive lane centering, etc.) may maintain or control the position of a vehicle with respect to the road with reduced driver input (e.g., steering wheel movement). In order to comply with safety requirements, however, the driver may need to regain full control of the vehicle steering controls and deactivate or disengage the steering control system. The driver may regain control of the vehicle, for example, when another vehicle swerves into the driver's lane, an obstacle lies in front of the vehicle, the vehicle comes into close proximity with a guardrail, the driver switches lanes, or in other circumstances. Once the driver has overridden the automated steering control system, the driver may later manually re-activate or re-engage the automated steering control system. If the driver frequently disengages the automated steering control system, it may become cumbersome for the driver to repeatedly re-activate the automated steering control system.

In one embodiment of the present invention, a vehicle may be equipped with an adaptive or automatic lane centering feature or application. An adaptive lane centering feature may maintain a constant lane offset, or vehicle position relative to a lane on the road the vehicle is driving upon. A computer vision sensor (e.g., a camera), LIDAR sensor, or other type of sensor may measure data allowing an adaptive lane centering feature to determine the lane offset or relative location of the vehicle with respect road features, for example, lane markers(s), road shoulder(s), median barrier(s), edge of the road and other objects or features. The relative location of the vehicle with respect to road features may be determined based on, for example, global positioning system (GPS) location data and a map database of the vehicle, a forward facing camera measured relative distance to road features, and/or other information. The adaptive lane centering feature may control the vehicle steering based on the determined relative position of the vehicle in order to maintain constant or relatively constant (e.g., with a resolution of 10 cm) vehicle lane offset or position within a lane.

In one embodiment of the present invention, a vehicle may be equipped with an automated lane keeping assist application or feature. A lane keeping assist application may automatically control the vehicle steering to ensure that the vehicle stays within a pre-determined lane or path on the road. A lane keeping assist application may, in some embodiments, not control the vehicle steering unless the vehicle begins to move out of a lane, at which point the lane keeping assist system may automatically control the steering to maintain the vehicle within the lane. A lane keeping assist feature may function by determining the relative position of the vehicle with respect to road features (e.g., lane marker(s), road shoulder(s), median barrier(s), or other road features) and adjusting the steering control to maintain the vehicle within a lane. The relative position of the vehicle with respect to road features may be determined based on the GPS location data of the vehicle, vehicle measured relative distance to road features, or other information. The lane keeping assist feature may control the vehicle steering based on the determined relative position of the vehicle in order to ensure the vehicle stays within a lane.

Embodiments of the present invention may determine, based on sensor (e.g., camera, steering angle sensor, accelerometer, rate gyro, speedometer, or other sensor) measured steering angle, lane offset, heading angle, lane curvature and/or other information (e.g., speed, acceleration, yaw-rate, other driver input etc.) of a vehicle, whether to engage, activate, actuate, re-activate, or re-engage an automatic vehicle control system. Embodiments of the present invention may, for example, be employed after the driver of a vehicle has manually overridden an automated vehicle steering system. The automated vehicle system may measure the steering angle, relative position of the vehicle with respect to the road, acceleration, speed, yaw-rate, and/or other factors during or over a pre-determined period of time. If, for example, the measured steering angle and/or relative position of the vehicle with respect to the road remain within pre-determined thresholds or ranges for a pre-determined period of time (e.g., five seconds or another period of time) indicating vehicle steadiness, an automated steering engagement method or system may automatically engage, actuate or activate an automated vehicle steering system (e.g., an adaptive lane centering feature, lane keeping assist feature, or other feature). Other thresholds may be used.

According to embodiments of the present invention, an automated steering engagement system may measure, evaluate, and/or estimate, using sensor(s) associated with the vehicle, the steering angle of a vehicle at pre-determined intervals (e.g., every 10 milliseconds or another period of time) while the vehicle is in motion. The system may calculate an average steering angle value for a pre-determined period of time (e.g., five seconds or another period of time) based on the measured or evaluated steering angle condition or information. The calculated average steering angle value may in some embodiments be a running average, moving average, or rolling average. The running average may correspond to a time period (e.g., five seconds or another time) prior to the time of calculation or another time period. The system may calculate at pre-determined intervals (e.g., every 10 milliseconds or another time) the difference between the measured steering angle at the current time, time instant, or time step and the calculated average steering angle value. If the calculated difference between the measured steering angle and the calculated average steering angle is within a certain range, limits and/or boundary (e.g., plus or minus 2° or another value), for a pre-determined amount of time (e.g., five seconds or another period of time), a vehicle may be considered to be in a steady state motion, and an automated vehicle steering system, automatic vehicle control system, or lane centering system may be automatically engaged. Similarly, if the calculated difference between the measured steering angle at the current time, time instant, or time step and the calculated average steering angle exceeds or is outside of a certain range, limits, and/or boundary (e.g., plus or minus 2° or another value), a vehicle may be considered to not be in steady state motion and an automated steering system or lane centering system may not be engaged.

According to embodiments of the present invention, an automated steering engagement system may measure, evaluate and/or estimate, using sensor(s) (e.g., a camera, LIDAR sensor) associated with the vehicle, the relative position of the vehicle with respect to features on the road (e.g., lane marker(s), road shoulder(s), median barrier(s), or other driving related features) at pre-determined intervals (e.g., every 10 milliseconds or another time). The automated steering engagement system may determine a vehicle lane position based on the vehicle lane offset and relative position of the vehicle with respect to the road or road features (e.g., lane marks). For example, a computer vision sensor (e.g., a forward facing camera) associated with a vehicle may detect lane markers on the road and measure a lane offset. An automated steering engagement system may calculate lane position with respect to the vehicle center in terms of lane offset, heading angle, lane curvature and other sensor measured data. The vehicle lane offset may be the relative position of the vehicle with respect to lane boundary markers (e.g., lane marker(s), road shoulder(s), edge of the road(s), or other feature(s)) and/or relative position of the vehicle within a lane. The system may calculate an average vehicle lane offset value during or over a pre-determined period of time, for example, five seconds or another period of time. The calculated average lane offset value may in some embodiments be a running average, moving average, or rolling average. The running average may correspond to a time period (e.g., five seconds or another time) prior to the time of calculation or another time period. The system may calculate at pre-determined intervals (e.g., every 10 milliseconds or another time) the difference between the measured lane offset at the current time, time instant, or time step and the calculated average lane offset value. The difference between the measured lane offset and the calculated average lane offset value may represent how much the vehicle deviates from steady vehicle motion. If the calculated difference between the measured lane offset and the calculated average lane offset is within a certain range, thresholds, limits and/or boundary (e.g., plus or minus 10 cm or another value), for a pre-determined amount of time (e.g., five seconds or another period of time), a vehicle may be deemed to be in a steady state motion with respect to road features, and an automated steering system may be automatically engaged. Similarly, if the calculated difference between the measured lane offset at the current time, time step, or time instant and the calculated average lane offset exceeds or is outside of a certain range, thresholds, limits and/or boundary (e.g., plus or minus 10 cm or another value), a vehicle may be deemed to be not in steady state motion and an automated steering system may not be engaged.

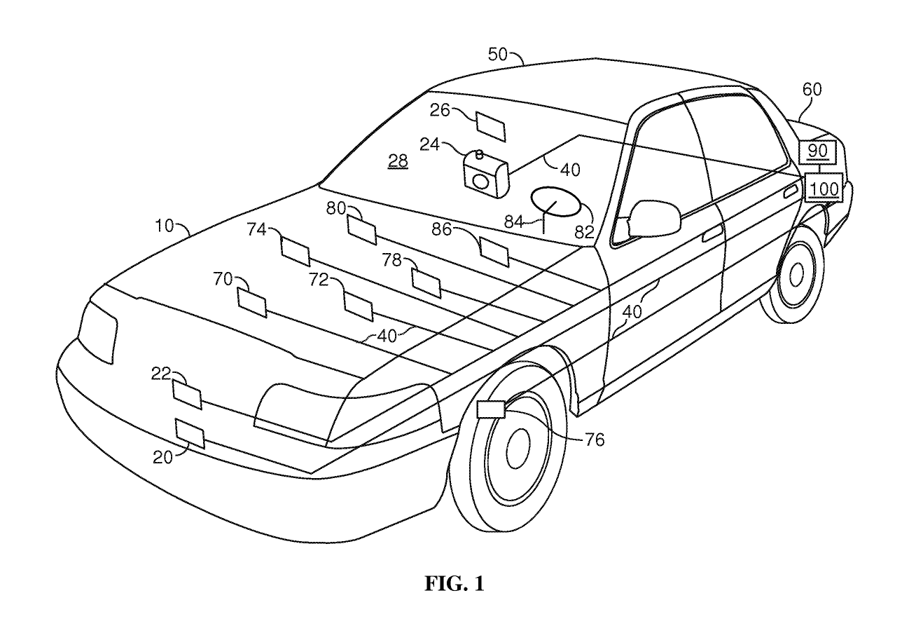

FIG. 1 is a schematic diagram of a vehicle with an automated steering engagement system according to an embodiment of the present invention. A vehicle 10 (e.g., a car, truck, or another vehicle) may include a vehicle automated steering engagement system 100. Vehicle automated steering engagement system 100 may operate in conjunction with or separate from one or more vehicle automated steering applications, features, systems or methods 90, for example, adaptive lane centering, low speed lane centering, lane keeping assist, or other applications. Vehicle automated steering system, automatic vehicle control system, or autonomous driving application 90 may be a component of system 100. Vehicle automated steering system 90 may be separate from system 100. Vehicle automated steering system 90 may, when engaged, fully or partially control the steering of the vehicle and reduce driver steering control input via steering wheel 82 and/or steering system 84, which may include an electrical power steering (EPS) system and/or other components.

One or more sensor(s) may be attached to or associated with the vehicle 10. A computer vision sensor (e.g., a camera) 24, LIDAR, or laser radar (LADAR), sensor 20, radar sensor 22, imager, or other remote sensing device may obtain data allowing system 100 to determine the relative location of the vehicle with respect to road features, for example, lane markers(s), road shoulder(s), median barrier(s), edge of the road and other objects or features.

In one embodiment, system 100 may use data sensed by one or more camera(s) 24 to determine the relative position of vehicle 10 with respect to road features. For example, a triangulation approach, image processing algorithm, or other method may be used. As vehicle 10 moves in reference to a road feature, camera 24 may capture a plurality of images of the road feature (e.g., lane markers). System 100 may determine the angle or angles of the line from camera 24 to road feature(s), offset distance from camera 24 to lane marks, orientation angle of the lane marks, road curvature, and other measured data. System 100 may use the measured data and plurality of images and determined angle(s) in a triangulation calculation method or an image processing algorithm to determine the relative location of the vehicle with respect to the road feature. The specific position and angle of view of camera 24 relative to the center point of vehicle 10 may be known and used for such calculations. Based on the relative position of vehicle 10 with respect to road features, system 100 may determine or calculate the vehicle lane offset or vehicle position within a lane.

In one embodiment, camera 24 may be forward facing (e.g., facing in the direction of typical travel), may image through windshield 28, and may be, for example, mounted to rear view mirror 26. Camera 24 may also be rearward facing (e.g., facing opposite the direction of typical travel). Camera 24 may also be positioned in another location (e.g. outside passenger compartment 50, on the rear of vehicle 10, or other location) and in any orientation with respect to vehicle 10. More than one camera 24 may be used, obtaining images from different points of view.

LIDAR sensor 20 and/or radar sensor 22 may determine the relative position of the vehicle with respect to road features (e.g., lane marker(s), road shoulder(s)). The relative position may be used to determine the vehicle lane offset or position. LIDAR sensor 20 and/or radar sensor 22 are preferably installed on the front or rear of vehicle but may also be installed on the sides or any other location on vehicle 10.

One or more sensor(s) 20, 22, 24 may transfer sensed data (e.g., images) to vehicle automated steering engagement system 100 via, e.g., a wire link (e.g., a controller area network bus CAN bus, Flexray, Ethernet) 40 or a wireless link. More than one sensor 20, 22, 24 may be associated with the vehicle obtaining information on object locations from different points of view.

In one embodiment of the present invention, vehicle automated steering engagement system 100 is or includes a computing device mounted on the dashboard of the vehicle, in passenger compartment 50 or in trunk 60, and may be part of, associated with, accept location information from, or include a conventional vehicle position system such as a GPS and map database. In alternate embodiments, vehicle automated steering engagement system 100 may be located in another part of the vehicle, may be located in multiple parts of the vehicle, or may have all or part of its functionality remotely located (e.g., in a remote server or in a portable computing device such as a cellular telephone).

In one embodiment of the present invention, vehicle 10 may include vehicle dynamics or driver input measurement devices. The vehicle dynamics measurement devices may include one or more steering angle sensor(s) 70 (e.g., connected to steering wheel 82 or another component of the steering system 84), accelerometer(s) 72, speedometer(s) 74, wheel speed sensor(s) 76, inertial measurement unit(s) (IMU) 78, steering torque sensor(s) 80, yaw-rate sensor 86, or other devices. The device(s) may measure vehicle dynamics data or driver input including steering angle, steering direction, lateral (i.e., angular or centripetal) acceleration, longitudinal acceleration, yaw-rate, speed, wheel rotation, and other vehicle dynamics characteristics of vehicle 10. The measured vehicle dynamics or driver input information may be transferred to system 100 via, for example, a wire link (e.g., a controller area network bus CAN bus, Flexray, Ethernet) 40 or a wireless link. The vehicle dynamics or driver input data may be used by system 100 or another system to calculate steering angle, dead reckoning based vehicle position, and other calculations.

While various sensors and inputs are discussed, in certain embodiments only a subset (e.g. one) type of sensor or input may be used.

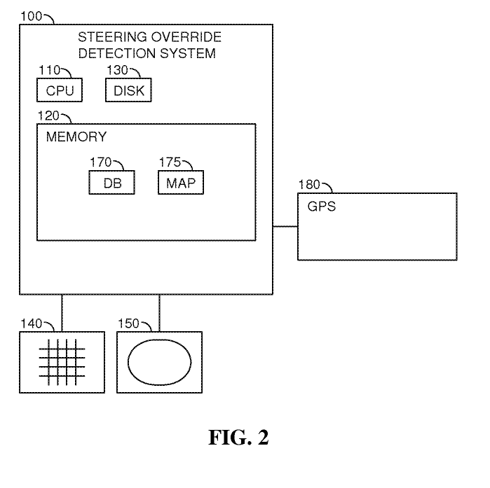

FIG. 2 is a schematic diagram of a vehicle automated steering engagement system according to an embodiment of the present invention. Vehicle automated steering engagement system 100 may include one or more processor(s) or controller(s) 110, memory 120, long term storage 130, input device(s) or area(s) 140, and output device(s) or area(s) 150. Input device(s) or area(s) 140 may be, for example, a touchscreen, a capacitive input device, a keyboard, microphone, pointer device, a button, a switch, a turn signal stalk switch, or other device. Output device(s) or area(s) 150 may be for example a display, screen, audio device such as speaker or headphones, or other device. Input device(s) or area(s) 140 and output device(s) or area(s) 150 may be combined into, for example, a touch screen display and input, which may be part of system 100. System 100 may include, be associated with, or be connected to a GPS system 180, or another system for receiving or determining location information, e.g., for vehicle 10. GPS system 180 may be located in the vehicle 10 in a location separate from system 100, and need not be used.

System 100 may include one or more databases 170, which may include, for example, vehicle dynamics or driver input information (e.g., steering angle thresholds or ranges, vehicle lane offset thresholds, and other vehicle dynamics measurement or parameter thresholds); sensor measured vehicle dynamics data (e.g., measured steering angle, vehicle lane offset, vehicle position, yaw-rate, acceleration, velocity and other measured vehicle dynamics data); vehicle dynamics measurement times; and geographic or three-dimensional (3D) position information of road features (e.g., lane marker(s), road shoulder(s), median barrier(s), etc.).

Databases 170 may be stored all or partly in one or both of memory 120, long-term storage 130, or another device. System 100 may include map data 175, although such data may be accessible remotely and may be stored separately from system 100. Map data may also be stored in database 170. Map data 175 may include the 3D locations, geometric shape, and/or appearance of road features (e.g., lane marker(s), lane curvature(s), lane fork(s), lane merge(s), road shoulder(s), etc.) previously measured by vehicle 10. Map data need not be used.

Processor or controller 110 may be, for example, a central processing unit (CPU), a chip or any suitable computing or computational device. Processor or controller 110 may include multiple processors, and may include general purpose processors and/or dedicated processors such as graphics processing chips. Processor 110 may execute code or instructions, for example stored in memory 120 or long term storage 130, to carry out embodiments of the present invention.

Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include multiple memory units.

Long term storage 130 may be or may include, for example, a hard disk drive, a floppy disk drive, a Compact Disk (CD) drive, a CD-Recordable (CD-R) drive, a universal serial bus (USB) device or other suitable removable and/or fixed storage unit, and may include multiple or a combination of such units.

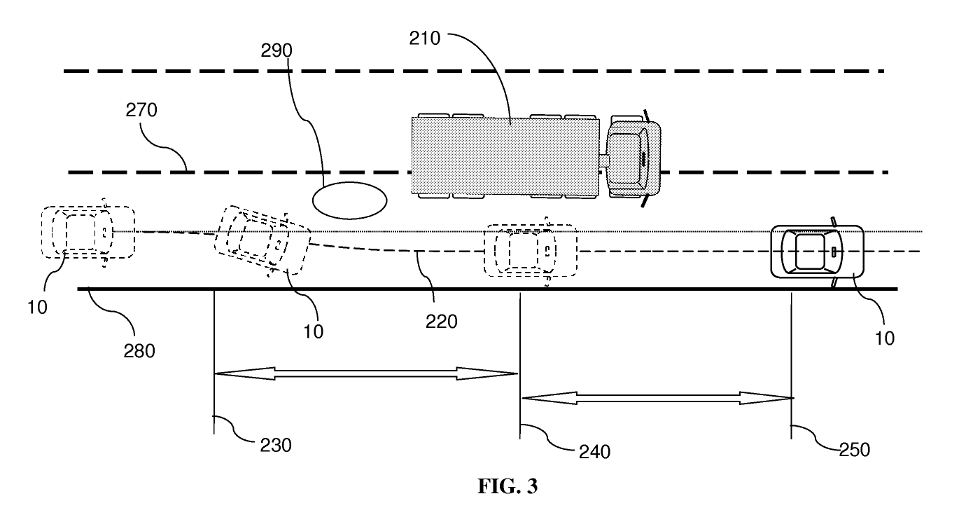

FIG. 3 is a schematic diagram of a vehicle automated steering engagement system according to an embodiment of the present invention. A vehicle 10 (e.g., a car or other type of vehicle) equipped with one or more sensor(s) may be in motion with an automated steering application engaged. While driving, vehicle 10 may travel along a vehicle path 220. Vehicle 10 may encounter a driving condition, obstacle, or road feature in the vehicle path 220 or close to vehicle path 220, for example, a stopped vehicle in the road 210, a pothole 290, road construction, or other condition. In response to driving condition 220, the driver may disengage an automated steering system 90 and manually steer vehicle 10. At time 230, vehicle automated steering system 90 may be disengaged. The vehicle automated steering engage system 100 may continue to measure vehicle dynamics measurements, motion conditions or parameters such as vehicle steering angle and/or vehicle lane offset. The vehicle lane offset may be determined, for example, based on the relative vehicle position with respect to road features, for example, lane marker(s) 270, road shoulder 280, other road features. In some embodiments, system 100 may measure steering angle and vehicle lane offset while the automated steering system 90 is engaged. System 100 may continuously measure vehicle steering angle and lane offset at pre-defined intervals or time steps (e.g., every 10 milliseconds or another time). Between time 230 and time 240, the driver may be changing the steering angle and/or position of vehicle 10 with respect to road, and vehicle steering angle and vehicle lane offset may, therefore, be unsteady. After time 240, vehicle may resume a constant or approximately constant steering angle and vehicle lane offset once driver input is steady. Time 240 may be the time when vehicle 10 is beyond driving condition 210. Vehicle 10 may maintain the constant or relatively constant steering angle and lane offset from time 240 to time 250. The period of time from time 240 to time 250 may be, for example, five seconds or another period of time. System 100 may calculate, based on measured vehicle steering angle and lane offset data, average steering angle and average lane offset during the period from time 240 to time 250.

System 100 may engage, activate, or re-engage an automated steering feature 90 once the vehicle motion or a vehicle path is steady, or on a relatively straight or smooth (e.g., curved) path, for pre-determined amount of time. In one embodiment, in order to determine vehicle steadiness or path smoothness, system 100 may calculate how much measured vehicle steering angle deviates from average steering angle during period from the time 240 to time 250. System 100 may calculate a maximum measured steering angle deviation from the average steering angle during the period from time 240 to time 250. If the calculated steering angle deviation values and/or the maximum calculated steering angle deviation values are within a predefined threshold or range, for example, plus or minus 2° or another value, from the calculated average steering angle value during the period from time 240 to time 250, system 100 may deem the path to be smooth, or the motion or path to be steady, and may engage a vehicle automated steering feature 90.

According to another embodiment of the present invention, system 100 may calculate how much the measured vehicle lane position deviates from the calculated average vehicle lane position during a period (e.g. from time 240 to time 250) in order to determine vehicle motion steadiness. System 100 may calculate a maximum measured vehicle lane offset deviation from the average vehicle lane offset during the period from time 240 to time 250. If the calculated vehicle lane offset deviation and/or maximum lane offset deviation values are within a predefined threshold or range, for example, plus or minus 10 cm or other values, from the calculated average lane offset value during the period from time 240 to time 250, system 100 may engage a vehicle automated steering control feature.

In some embodiments of the present invention, system 100 may engage a vehicle automated steering feature if some combination of calculated steering angle deviation values, vehicle motion values or conditions, and calculated vehicle lane offset deviation values are within predetermined thresholds of the calculated average steering angle deviation values, vehicle motion values or conditions, and/or calculated vehicle lane offset values during the time period from time 240 to time 250.

In some embodiments, system 100 may use other vehicle dynamics or driver input measurements, motion conditions or parameters including, for example, yaw-rate, acceleration, lateral and longitudinal velocity and other vehicle dynamics measurements or motion conditions to determine vehicle or path steadiness or constancy. System 100 may measure vehicle dynamics measurements, calculate average vehicle dynamics measurement values and calculate how much measured vehicle dynamics measurements deviate from average vehicle dynamics measurements using similar systems or methods to those used for steering angle and vehicle lane offset.

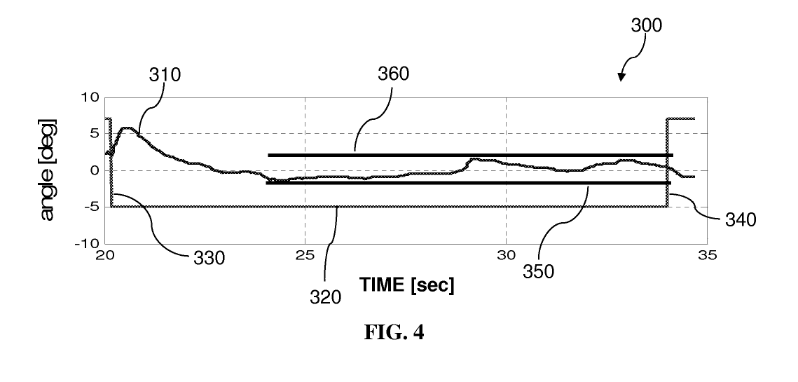

FIG. 4 is a graph of vehicle steering angle measurements with respect to time according to an embodiment of the present invention. FIG. 4 may represent an example of the operation and/or function of the automated vehicle steering engagement system or method according to an embodiment of the present invention. Graph 300 may represent the steering angle of a vehicle during manual steering wheel operation, for example, when an automated vehicle steering control system 90 is disengaged. Graph segment 310 may represent vehicle steering angle, in units of degrees (°), during or over a period of time. Graph segment 320 may represent the state of a vehicle automated steering control system 90, for example, whether a vehicle automatic control system 90 is engaged or disengaged. For example, if graph segment 320 is high, vehicle automated steering control system 90 may be activated, and if graph segment 320 is low, vehicle automated steering control system 90 may be de-activated. Graph segment 330, which is a portion of graph segment 320, may represent a vehicle automated steering control system disengage, or de-activation, event. A vehicle automated steering control system disengage event may, for example, occur when the driver takes control of the steering wheel to maneuver around a driving condition or obstacle 290. Graph segment 340, which is portion of graph segment 320, may represent a vehicle automated steering control system activation, engagement, or actuation event, for example, when system 100 activates, re-activates or re-engages a vehicle automated steering control system 90. Vehicle automated steering control activation event 340 may also occur when driver engages an automated steering control system 90.

System 100 may continuously or periodically measure the vehicle steering angle at pre-defined intervals or time steps (e.g., every 10 milliseconds or another time). System 100 may calculate, based on measured vehicle steering angle data, an average steering angle value during a predetermined period of time, for example, five seconds or another period of time. The calculated average steering angle value may be for example a running average, moving average, or rolling average. The running average may correspond to a time period (e.g., five seconds or another time) prior to the time of calculation or another time period. Lower threshold vehicle steering angle 350 may represent a lower threshold, boundary or limit steering angle. Upper threshold vehicle steering angle 360 may represent an upper threshold, boundary or limit steering angle. Lower threshold 350 and upper threshold 360 may be determined by system 100 based on the average calculated steering angle value(s) and predetermined steering angle deviation parameters or measurement values. Lower threshold 350 may, for example, be a steering angle value that is less than an average calculated steering angle value(s) by a predefined steering angle deviation parameter or measurement value, for example, 2° or another value, or a percentage. Upper threshold 360 may, for example, be a steering angle value that is greater than the average calculated steering angle value(s) by a predefined steering angle deviation parameter or measurement value, for example, 2° or another value, or a percentage. Other thresholds may be used. Lower threshold 350 and upper threshold 360 may, in some embodiments, be unrelated and/or be calculated or determined independently of the average calculated steering angle value(s).

System 100 may determine whether measured vehicle steering angle values over a period of time (e.g., 5 seconds) are within or between lower threshold 350 and upper threshold 360. If graph segment 310, representing the measured steering angles, is within lower threshold 350 and upper threshold 360 for a pre-determined period of time (e.g., 5 seconds or any other period of time), system 100 may deem the path of vehicle motion or path to be steady and activate automated vehicle steering control system 90. Thus, if the vehicle path of motion is steady, or approximately steady, for a pre-determined period of time, system 100 may activate automated steering control system 90. If graph segment 310, representing measured steering angles, is less than lower threshold 350 or greater than upper threshold 360 during the pre-determined period of time, automated vehicle steering control system 90 will not be activated and the driver may remain in control of the vehicle steering. Other thresholds may be used.

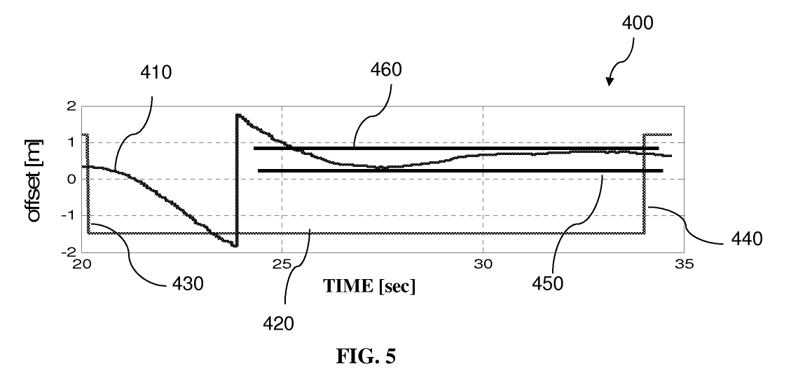

FIG. 5 is a graph of vehicle lane offset with respect to time according to an embodiment of the present invention. FIG. 5 may represent an example of the operation and/or function of the automated vehicle steering engagement system or method according to an embodiment of the present invention. Graph 400 may represent the vehicle lane offset of a vehicle during manual steering operation, for example, when an automated vehicle steering control system 90 is disengaged. Vehicle lane offset may be measured, for example, by a forward facing camera 24. Graph segment 410 may represent vehicle lane offset over a period of time. Graph segment 420 may represent the state of a vehicle automated steering control system 90, for example, whether a vehicle automatic control system 90 is engaged or disengaged. For example, if graph segment 420 is high, vehicle automated steering control system 90 may be activated, and if graph segment 420 is low, vehicle automated steering control system 90 may be de-activated. Graph segment 430, which is portion of graph segment 420, may represent a vehicle automated steering control system disengage, or de-activation, event. A vehicle automated steering control system disengage event may, for example, occur when the driver takes control of the steering wheel and/or vehicle steering system, for example, to maneuver around a driving condition or obstacle 210. Graph segment 440, which is a portion of graph segment 420, for example, may represent a vehicle automated steering control system activation, engagement or actuation event, for example, when system 100 activates, re-activates or re-engages a vehicle automated steering control system 90. Vehicle automated steering system activation event 440 may also occur not based on vehicle dynamics measurements, e.g. when driver activates, re-activates or re-engages an automated steering control system 90 (e.g., by pressing a button).

System 100 may continuously or periodically measure lane offset, for example, at pre-defined intervals or time steps (e.g., every 10 milliseconds or another time). System 100 may measure (using sensors) and calculate, based on measured vehicle lane offset data, an average lane offset value during a predetermined period of time, for example, five seconds or another period of time. The calculated average lane offset value may in one embodiment be a running average, moving average, or rolling average. The running average may correspond to a time period (e.g., five seconds or another time) prior to the time of calculation or another time period. Lower threshold vehicle lane offset 450 may represent a lower threshold, boundary or limit vehicle lane offset. Upper threshold vehicle lane offset 460 may represent an upper threshold, boundary or limit vehicle lane offset. Lower threshold 450 and upper threshold 460 may be determined by system 100 based on the average calculated vehicle lane offset value(s) and predetermined vehicle lane offset deviation parameters or measurement values. Lower threshold 450 may, for example, be a vehicle lane offset value that is less than an average calculated vehicle lane offset value(s) by a predefined vehicle lane offset deviation parameter or measurement value (e.g., 10 cm or another value or percentage). Upper threshold 460 may, for example, be a lane offset value which is greater than the average calculated lane offset value(s) by a predefined lane offset deviation parameter or measurement value (e.g., 10 cm or another value or percentage). Lower threshold 450 and upper threshold 460 may, in some embodiments, be unrelated and/or be calculated or determined independently of the average calculated lane offset value(s).

System 100 may determine whether measured vehicle lane offset values over a period of time (e.g., 5 seconds or another time period) are between lower threshold 450 and upper threshold 460. If graph segment 410, representing the measured lane offset, is between lower threshold 450 and upper threshold 460 for a pre-determined period of time (e.g., 5 seconds or any other period of time), system 100 may deem the path or vehicle motion to be steady and activate an automated vehicle steering control system 90. If graph segment 410, representing measured vehicle lane offset, is less than lower threshold 450 or greater than upper threshold 460 during a pre-determined period of time (e.g., 5 seconds or any other period of time), an automated vehicle steering control system 90 will not be activated, and the driver may remain in control of the vehicle steering.

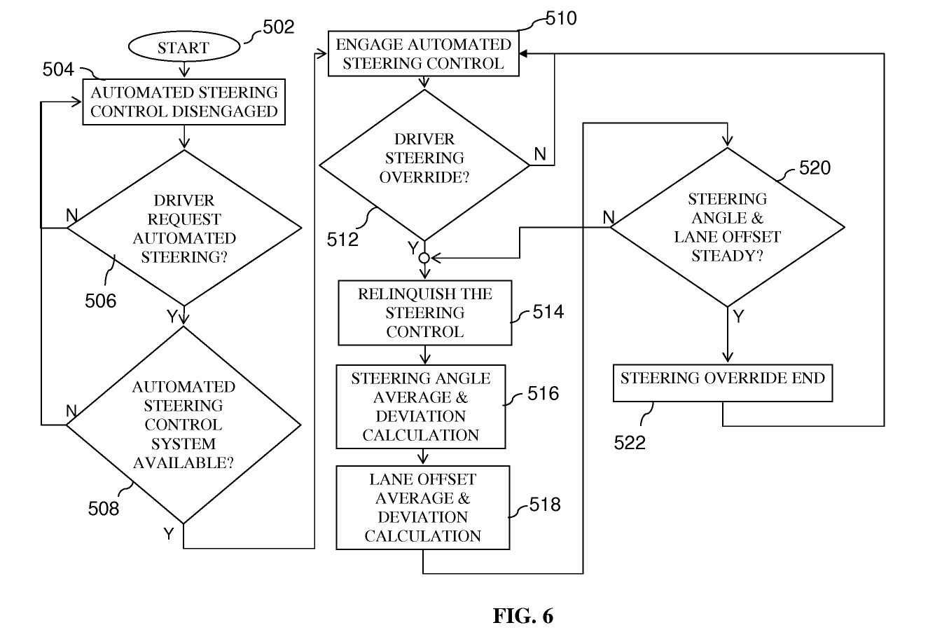

FIG. 6 is a flowchart of a method according to an embodiment of the invention. The operations may be carried out by vehicle location system 100 or by other systems associated with or separate from vehicle 10. As depicted in blocks 502 and 504, the system or process may be initiated when the vehicle automated steering control system 90 is disengaged, not engaged or not activated. As illustrated by block 506, an action (e.g., a push of a button, activation of a switch, etc.) may be performed by an operator of the vehicle or driver to engage an automated steering control system 90. As illustrated in block 508, it may be determined by system 100 whether the automated steering control system is available and may be activated. As depicted in block 510, if automated steering system 90 is available, the system may be engaged. When engaged, the automated steering system 90 may then automatically control the direction and/or heading of vehicle travel by adjusting the steering actuator. As depicted in block 512, at any time while the automated steering system 90 is engaged, the operator of the vehicle may override, disengage, or deactivate automated steering system 90 by, for example, applying torque to the steering wheel, turning the steering wheel beyond a pre-determined threshold angle, or other actions. As depicted in block 514, control of the vehicle may be relinquished by the steering control system to the operator or driver. While the operator manually controls the vehicle steering, steering angle measurements may be made by system 100.

As illustrated in block 516, based on the steering angle measurements, an average steering angle over a pre-determined period of time, for example, 5 seconds or another period of time may be calculated by system 100. The difference between measured steering angle measurements and the calculated average steering angle, or vehicle steering angle deviation, may be calculated by system 100, as depicted in block 516.

As illustrated in block 518, based on the vehicle lane offset measurements, an average vehicle lane offset over a pre-determined period of time (e.g., 5 seconds or another period of time) may be calculated by system 100. The difference between measured vehicle lane offset measurements and the calculated average vehicle lane offset, or vehicle lane position deviation, may be calculated by system 100, as depicted in block 518. As discussed, in some embodiments, only one of steering angle or lane offset may be used; in other embodiments a combination of these and/or other factors may be used.

As illustrated by block 520, it may be determined by system 100 whether the vehicle motion conditions or dynamics or driver input are steady. Steadiness may be determined by determining whether the calculated vehicle steering angle deviation and vehicle lane position deviation over a pre-determined period of time are less than predetermined vehicle steering angle and vehicle steering angle deviation thresholds. As illustrated in block 520, if one or more calculated vehicle steering angle and/or vehicle lane offset deviation values over a pre-determined period of time are greater than predetermined steering angle and/or vehicle lane centering thresholds, the vehicle is not steady and a vehicle automated steering control system 90 may remain de-activated or disengaged. If the calculated vehicle steering angle and vehicle lane offset deviation values over a pre-determined period of time are less than predetermined steering angle and vehicle lane centering thresholds, then it may be determined that the motion or dynamics or driver input of the vehicle is steady, and the automated steering control system override may end, as illustrated in block 522. As illustrated in blocks 522 and 510, if the vehicle is determined to be steady (e.g., if it is determined that the operator of the vehicle is not overriding a vehicle steering system 90), an automated steering control system 90 may be automatically engaged, activated or actuated. An alert, indication, alarm or signal may be provided to the driver by system 100 prior to or after engaging the automated steering control system 90. The alert may be, for example, an audible alert, light, signal, notification or other form of alert.

Other or different series of operations may be used.

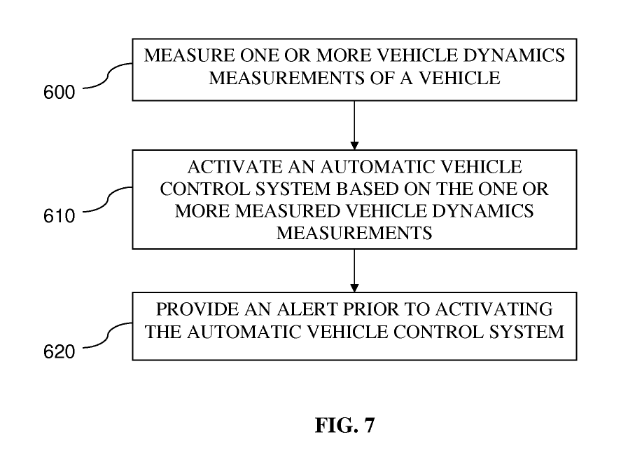

FIG. 7 is a flowchart of a method according to an embodiment of the present invention.

In operation 600, one or more vehicle dynamics measurements of a vehicle may be measured. The one or more vehicle dynamics measurements may, for example, be measured by steering torque sensor (e.g., steering torque sensor 80 of FIG. 1), computer vision sensor (e.g., camera 24 of FIG. 1), laser radar device (e.g., LIDAR sensor 20 of FIG. 1), or other device.

In operation 610, an automatic vehicle control system (e.g., system 90 in FIG. 1) may be activated based on the one or more measured vehicle dynamics measurements. The one or more vehicle dynamics measurements may include, for example, a vehicle steering angle measurement, vehicle lane offset measurement, vehicle yaw-rate, vehicle lateral acceleration, vehicle longitudinal acceleration, or other vehicle dynamics measurements.

In operation 620, system 100 may provide an alert prior to activating the automatic vehicle control system 90. The alert may be output, for example, to a driver or to a vehicle automatic vehicle control system 90. The alert may inform the driver that the automatic vehicle control system 90 may be engaged or is soon to be engaged.

Other or different series of operations may be used.

Embodiments of the present invention may include apparatuses for performing the operations described herein. Such apparatuses may be specially constructed for the desired purposes, or may include computers or processors selectively activated or reconfigured by a computer program stored in the computers. Such computer programs may be stored in a computer-readable or processor-readable non-transitory storage medium, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions. It will be appreciated that a variety of programming languages may be used to implement the teachings of the invention as described herein. Embodiments of the invention may include an article such as a non-transitory computer or processor readable non-transitory storage medium, such as for example a memory, a disk drive, or a USB flash memory encoding, including or storing instructions, e.g., computer-executable instructions, which when executed by a processor or controller, cause the processor or controller to carry out methods disclosed herein. The instructions may cause the processor or controller to execute processes that carry out methods disclosed herein.

Features of various embodiments discussed herein may be used with other embodiments discussed herein. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

What is claimed is:

1. A method comprising:
measuring one or more vehicle dynamics measurements of a vehicle; and
activating an automatic vehicle control system based on the one or more measured vehicle dynamics measurements.

2. The method of claim 1, wherein the one or more vehicle dynamics measurements comprise a vehicle steering angle measurement and a vehicle lane offset measurement.

3. The method of claim 1, comprising:
calculating, based on the one or more measured vehicle dynamics measurements, one or more average vehicle dynamics measurement values during a pre-determined period of time; and
calculating, based on the one or more calculated average vehicle dynamics measurement values, one or more vehicle dynamics measurement thresholds.

4. The method of claim 1, wherein activating the automatic vehicle control system based on the one or more measured vehicle dynamics measurements comprises determining whether the one or more measured vehicle dynamics measurements exceeds one or more vehicle dynamics measurement thresholds.

5. The method of claim 1, wherein the automatic vehicle control system comprises an automated lane centering system.

6. The method of claim 1, wherein activating the automatic vehicle control system based on the one or more measured vehicle dynamics measurements comprises determining whether a path of the vehicle is steady.

7. The method of claim 1, comprising providing an alert prior to activating the automatic vehicle control system.

8. A system comprising:
an automated vehicle steering system;
one or more sensors; and
a controller to:
measure one or more vehicle dynamics measurements of a vehicle using the one or more sensors; and
activate the automated vehicle steering system based on the one or more measured vehicle dynamics measurements.

9. The system of claim 8, wherein the one or more vehicle dynamics measurements comprise a vehicle steering measurement and a vehicle lane offset measurement.

10. The system of claim 8, wherein the controller is to:
calculate, based on the one or more measured vehicle dynamics measurements, one or more average vehicle dynamics measurement values during a predetermined period of time; and
calculate, based on the one or more calculated average vehicle dynamics measurement values, one or more vehicle dynamics measurement thresholds.

11. The system of claim 8, wherein to activate the automated vehicle steering system based on the one or more measured vehicle dynamics measurements the controller is to determine whether the one or more measured vehicle dynamics measurements exceeds one or more calculated vehicle dynamics measurement thresholds.

12. The system of claim 8, wherein the automated vehicle steering system comprises an automated lane centering system.

13. The system of claim 8, wherein the controller is to activate the automated vehicle steering system if a path of the vehicle is steady.

14. The system of claim 8, wherein the controller is to provide one or more alerts prior to activating the automated vehicle steering system.

15. A method comprising:
in a vehicle, evaluating a plurality of vehicle motion conditions using a plurality of sensors associated with the vehicle; and
engaging an autonomous driving application if the evaluated vehicle motion conditions indicate the operator of the vehicle is not overriding the autonomous driving application.

16. The method of claim 15, wherein the plurality of vehicle motion conditions comprise a vehicle steering angle condition and a vehicle relative position with respect to one or more road features.

17. The method of claim 15, wherein the plurality of sensors are a steering angle sensor and a camera.

18. The method of claim 15, comprising:
determining, based on the one or more evaluated vehicle motion conditions, one or more average vehicle motion conditions values during a predetermined amount of time; and
determining, based on the one or more determined average vehicle motion condition values, one or more vehicle motion condition thresholds.

19. The method of claim 15, wherein engaging the autonomous driving application if the evaluated vehicle motion conditions indicate the operator of the vehicle is not overriding the autonomous driving application comprises evaluating whether the one or more measured vehicle motion conditions exceeds one or more vehicle motion condition thresholds.

20. The method of claim 15, wherein the autonomous driving application comprises adaptive lane centering.
